(19) United States
(12) Patent Application Publication
(10) Pub. No.: US 2025/0350599 A1
(43) Pub. Date: Nov. 13, 2025

(54) METHODS FOR USER CONSENT MANAGEMENT USING OPEN VEHICLE SIGNAL STANDARDS AND PERSONAL DIGITAL KEYS

(71) Applicant: Volvo Car Corporation, Göteborg (SE)

(72) Inventor: Peter Winzell, Mountain view (CA)

(21) Appl. No.: 18/656,867

(22) Filed: May 7, 2024

(51) Int. Cl. H04L 9/08; G07C 9/00

(52) U.S. Cl. CPC H04L 63/10

(57) ABSTRACT

Techniques are described that facilitate remote control of vehicle functions by the employment of a private digital key that enables a user to remotely control one or more functions of the vehicle and store information; and a digital key component that adds a new protocol to the private digital key to regulate consent management for a vehicle and support multiple brands.

### TECHNICAL FIELD

Embodiments disclosed and claimed herein relate to vehicle remote control of vehicle functions and applications rendered by an auxiliary device using a digital personal key with consent management.

### BACKGROUND

Many individuals have become accustomed to interacting with electronic devices by a simple swipe or touch of a finger due to rapid increase in smartphone and tablet use. For example, many vehicles are implemented with ability to be controlled remotely by auxiliary devices (cell phones, tables, and similar) for different functions in the vehicle, including locking and unlocking doors, infotainment systems, heating, ventilation, air conditioning (HVAC) controls, navigation system, backup camera and various settings. Vehicles and connected vehicle services and applications, for example navigation, charging and parking often rely on stored personal and private data. Privacy laws such as the European Union (EU)'s General Data Protection Regulation (GDPR) and the California Consumer Privacy Act (CCPA) are forcing providers of such services to implement consent management tools in-order to follow these laws.

### SUMMARY

The following presents a summary to provide a basic understanding of one or more embodiments of the invention. This summary is not intended to identify key or critical elements or delineate any scope of the different embodiments or any scope of the claims. Its sole purpose is to present concepts in a simplified form as a prelude to the more detailed description that is presented later. In one or more embodiments described herein, systems, computer-implemented methods, apparatus and/or computer program products are presented that facilitate remotely controlling vehicle functions and applications accessed by a remote auxiliary device that employs a private digital key to maintain privacy and consent management.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a remote-control component with a private digital key that enables a user to remotely control one or more functions of the vehicle as locking and unlocking doors, temperature settings within the vehicle, access and ability to control selections on an infotainment system and store information. In various aspects, the computer-executable components can comprise a private digital key component that adds a new protocol to the private digital key to regulate consent management for a vehicle and support multiple brands execution component. This digital key can contain various configurations that control consent by the user related to vehicle actions and stored private data. An auxiliary device that facilitates remotely controlling functions of a vehicle can be provided. The auxiliary device which for example can be a cell phone, tablet or any other communication capable device that can comprise a display and a processor that executes computer executable components stored in at least one memory. The computer executable component can include a session activation component that facilitates establishing a secure connection between the auxiliary device and an onboard computing system of the vehicle, and an interface acquisition component that determines touch controls included in a graphical user interface (GUI) configured for displaying on a touchscreen of the vehicle, wherein the touch controls provide for controlling functions of the vehicle based on first interaction with the touch controls as displayed on the touchscreen. The computer executable components can further comprise a display control component that controls display of a representation of the graphical user interface via the display of the auxiliary device, the representation comprising one or more graphical controls corresponding to one or more touch controls on the display or and the auxiliary device, and a remote-control component that provides for remotely controlling one or more functions of the functions of the vehicle based on second interaction with one or more auxiliary devices.

In some implementations, wherein the connection comprises a wireless connection and wherein the remote-control component enables the remote control based on establishment of the connection between the auxiliary device and the onboard computing system. For example, the onboard computing system can comprise a remote-control unit that controls execution of the one or more functions and wherein the remote-control component directs the remote-control unit to execute the one or more functions in response to the second interaction with the one or more graphical controls as displayed via the display or an auxiliary device.

In some implementations, the remote-control component can select one or more controls based on usage privileges granted to the auxiliary device or a user of the auxiliary device, a context of the vehicle and/or a location of the auxiliary device relative to the vehicle. In these implementations, usage privileges can be stored in a digital key which can be located in both the vehicle and the auxiliary device or in a cloud-based platform. The auxiliary device can also include a machine learning component that learns behavior of a user of the auxiliary device in association with usage of various actions to remotely control the one or more function and modifies certain controls based on the behavior.

One or more additional embodiments are directed to a computer program product that facilitates remotely controlling functions of a vehicle, the computer program product comprising readable storage medium having program instructions embodied therewith. The program instructions can be executable by a processor to cause the processor to perform certain actions, including controlling one or more functions of the vehicle as locking and unlocking doors, temperature settings within the vehicle, access and the ability to control selections on the infotainment system and store information. Also in another embodiment, the program instructions can be executable by a processor to cause the processor to perform actions utilizing a private digital key with an additional new protocol to regulate consent management for a vehicle and support multiple brands execution component. This digital key can contain various configurations that control consent by the user related to vehicle actions and stored private data.

Another embodiment is directed to a system located on or within a vehicle, the system comprising a touchscreen that displays a graphical user interface comprising touch controls that control functions of the vehicle, and a processor that executes computer executable components stored in at least one memory. The components can include a session activation component that facilitates establishing a secure connection between the system and one or more auxiliary devices, and a remote-control unit that enables, based on establishment of the secure connection, remote control of one or more functions of the functions of the vehicle by one or more auxiliary devices based on interaction with a representation of the graphical user interface rendered at the one or more auxiliary devices, wherein the representation comprises one or more touch controls for vehicle actions.

In some implementations, the system further comprises a privileges configuration component of the remote-control unit that facilitates defining usage privileges located in a digital key within the vehicle or the cloud for enabling the remote control of the one or more functions by the one or more auxiliary devices. The system can also comprise a control management component of the remote-control unit that controls activating and deactivating remote control of the one or more vehicle functions by one or more auxiliary devices. In addition, in some implementations, the one or more auxiliary devices comprise at least two auxiliary devices, and the system further comprises a conflict resolution capability of the remote-control unit that can use digital key configuration that resolves conflicting control commands for remotely controlling a function of the one or more functions, the conflicting control commands being received from at least two auxiliary devices at or near a same time.

In some embodiments, elements described in connection with the disclosed systems can be embodied in different forms such as a computer-implemented method, a computer program product, or another form.

### DESCRIPTION OF THE DRAWINGS

FIG. 1 illustrates a block diagram of an example, non-limiting system that facilitates remotely controlling vehicle functions and applications rendered at an auxiliary device in accordance with one or more embodiments described herein.

FIG. 2 illustrates a block diagram of an example, non-limiting auxiliary device that facilitates remotely controlling vehicle functions and applications in accordance with one or more embodiments described herein.

FIG. 3 illustrates a block diagram of an example non-limiting digital key incorporated auxiliary device communication flow to external servers in accordance with one or more embodiments described herein.

FIG. 4 presents a diagram of the basic Vehicle Signal Specification (VSS) layout in accordance with one or more embodiments described herein.

FIG. 5 presents an illustration of an example, non-limiting remote-control application utilizing a digital key with consent configuration in accordance with one or more embodiments described herein.

FIG. 6 illustrates a communication diagram of consent being revoked related to the usage of a digital key and VSS in accordance with one or more embodiments described herein.

FIG. 7 illustrates a communication diagram of modifying consent related to the usage of a digital key and VSS in accordance with one or more embodiments described herein.

FIG. 8 illustrates a communication diagram of a digital key and VSS supporting multiple OEM (vehicle brands) in accordance with one or more embodiments described herein.

FIG. 9 illustrates a flow diagram of a digital key and VSS supporting multiple OEM (vehicle brands) in accordance with one or more embodiments described herein.

FIG. 10 illustrates a block diagram of an example, non-limiting operating environment in which one or more embodiments described herein can be facilitated.

FIG. 11 illustrates an example networking environment operable to execute various implementations described herein.

### DETAILED DESCRIPTION

The following detailed description is merely illustrative and is not intended to limit, claims, embodiments and/or application or uses of embodiments. Furthermore, there is no intention to be bound by any expressed or implied information presented in the preceding Summary section or in the Detailed Description section.

One or more embodiments described herein is directed to remotely controlling vehicle functions rendered at an auxiliary device by employing a private digital key. A digital car key, also known as a virtual car key or mobile car key, is a technology that allows a user to employ a smartphone or other auxiliary digital device to lock, unlock, start a car along with other potential functions. Instead of carrying a physical key, one can use an app on a smartphone or another auxiliary device to perform these functions remotely. Private digital car keys can utilize technologies like Bluetooth Low Energy (BLE), Near Field Communication (NFC) or other methods to communicate with a vehicle's onboard systems.

A vehicle digital key typically contains encrypted data that serves as a digital representation of a physical key or key fob used to access and operate a vehicle. This data includes information such as authentication information that can verify the digital key is legitimate and authorized to access the vehicle. The key can also contain vehicle identification details about the vehicle itself, such as its make, model, and possibly its unique identification number (VIN). Also, user permissions, information about the user's privileges, such as whether they have permission to start the engine, unlock doors, or access certain features within the vehicle. The key can also contain specific security protocols, encryption keys and algorithms used to secure communication between the digital key and the vehicle's onboard systems, preventing unauthorized access or tampering. The digital key can contain remote access codes and for vehicles equipped with remote unlocking or starting capabilities, the digital key may contain codes or tokens that enable these functions. Some digital keys can record usage data, such as when and where the vehicle was accessed, which can be useful for tracking and monitoring purposes. Depending on the vehicle's capabilities and the digital key system in use, there may be additional features or data stored within the key, such as preferences for seat positions, climate control settings, and entertainment system presets.

Overall, the contents of a vehicle digital key are designed to securely authenticate a user and grant access to the vehicle while protecting against unauthorized use or tampering.

Digital car keys typically work through a smartphone app. The app may be developed by the car manufacturer or a third-party provider and is typically compatible with various operating systems like iOS or Android devices and can integrate with other operating systems based on compatibility. There are many remote functions supported by a digital car key, one can typically perform functions remotely, such as locking and unlocking doors, starting an engine, and sometimes even controlling other vehicle features like climate control or lights. Security is a crucial aspect of digital car keys; the keys often incorporate encryption and other security measures to prevent unauthorized access. Some keys may require biometric authentication (such as fingerprint or facial recognition) on a smartphone for added security. Digital car keys can often be shared with others digitally. This feature is useful for lending a car to family members or friends temporarily without needing to physically hand over a key. Manufacturers may also provide backup options in case the smartphone battery dies or the digital key malfunctions. This can include physical key fobs or alternative access methods. Some digital car key apps integrate with other services, such as vehicle monitoring, maintenance reminders, or remote assistance. Depending on the app and vehicle model, users may be able to customize settings and preferences related to their digital key, such as the range of operation or notification preferences.

These details can vary from one car manufacturer to another and may also depend on the specific model and year of the vehicle. As technology continues to advance, additional features and improvements to digital car keys are likely to emerge. Consent management is a significant aspect of digital keys. Consent management for digital keys refers to a process of controlling and managing permissions granted by users to access and use their digital car keys. It involves ensuring that users have the ability to grant or revoke consent for various actions related to their digital keys, such as sharing access with others or allowing certain functionalities. This may involve confirming permissions through the mobile app or other user interfaces. There is also a feature called granular permissions which is that consent management systems should allow users to specify level of access granted to others when sharing digital keys. For example, users may choose to grant full access to their vehicle or limit access to certain features or time periods. Also, for digital keys, there is the ability to revoke consent: Users should have the ability to revoke consent at any time. This means they can remove access permissions previously granted to others or disable specific functionalities associated with their digital keys. Consent management systems can provide clear and transparent information to users about how their digital keys are being used, who has access to them, and for what purposes. This helps users make informed decisions about granting or revoking consent.

Consent management systems can also be designed with robust security measures to protect users' privacy and prevent unauthorized access to their digital keys. This may include encryption, authentication mechanisms, and secure storage of consent preferences. It can be beneficial to maintain audit trails that track consent-related activities, such as when permissions were granted or revoked, and by whom. This helps ensure accountability and transparency in the management of digital keys. Consent management systems can comply with relevant data protection regulations and privacy laws, such as the General Data Protection Regulation (GDPR) in Europe or the California Consumer Privacy Act (CCPA) in the United States.

By implementing effective consent management practices, digital key providers can empower users to maintain control over their access permissions and privacy preferences, while also promoting trust and transparency in use of digital key technologies.

There is evidence that many current original equipment manufacturer (OEM) solutions are insufficient as far as fully conforming to privacy laws and in some cases even in direct violation of the GDPR and CCPA. This innovation provides a solution to this problem by introducing a digital key with a user consent protocol built in. The protocol uses an open vehicle data standard—VSS (vehicle_signal_specification) and the vehicle signal specification serves as a basis for a user consent protocol and together with a digital key concept presents a solution that can support multiple vehicle brands and services/applications. This is a novelty of embodiments. This innovation adds a protocol to a digital key that lets it hold information on multiple physical vehicles and their associated services/applications. It is an extension of a digital key and its functions. The connection between (VSS) and a vehicle digital key lies in integration of security protocols, authentication mechanisms, and compatibility requirements.

Vehicle digital keys need to adhere to security standards (VSS) outlined by the automotive industry to ensure that they provide robust protection against unauthorized access and tampering. These standards often dictate encryption algorithms, key exchange protocols, and other security measures to safeguard the communication between the digital key and the vehicle. VSS may define authentication mechanisms that digital keys must support to ensure that only authorized users can access and operate the vehicle. This could include biometric authentication, two-factor authentication, or other methods to verify the identity of the user.

Vehicle digital keys must be compatible with the vehicle's onboard systems and infrastructure. Vehicle specification standards may outline requirements for the integration of digital key technology into vehicles, ensuring interoperability across different manufacturers and models. While vehicle specification standards may not directly dictate format of digital keys, they may influence the data exchange formats (for example JSON, JavaScript Object Notation) used for transmitting digital key information between vehicles, mobile devices, and backend systems. This could include standards for encoding vehicle identification information, user permissions, and access control policies.

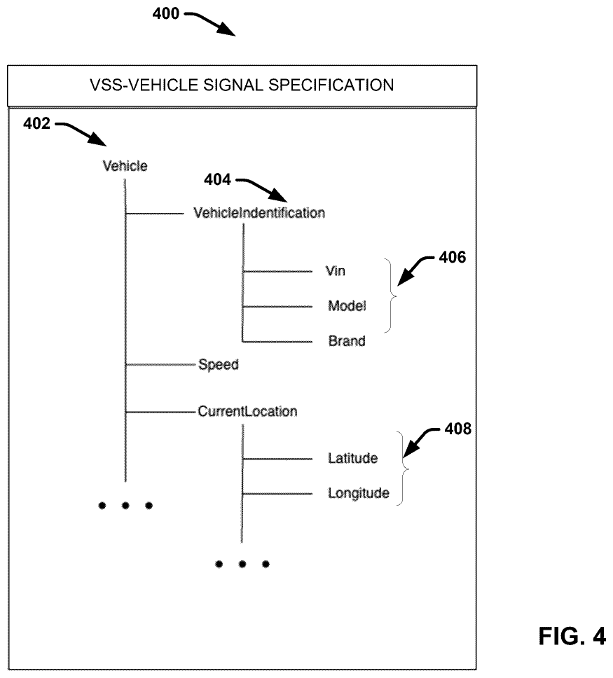

Overall, the connection between vehicle specification standards and vehicle digital keys lies in ensuring that digital key technology aligns with industry-wide best practices, security standards, and interoperability requirements to deliver a seamless and secure user experience across different vehicles and manufacturers. For each service/application a JSON formatted file is connected including a subset of the vehicle signal specification. JSON is an open standard file format and data interchange format that uses human-readable text to store and transmit data objects consisting of attribute-value pairs and arrays. It is a commonly used data format with diverse uses in electronic data interchange, including that of web applications with servers. Also with the tree structure, of VSS (further described in FIG. 4) one is able to reach service associates, and specify exact data usage. The tree structure also guarantees that the expression uses minimal amount of information needed.

Since the digital key is tied to an individual, it is personal by its very nature. The digital key has multiple entries for vehicles, and thus can be used for personal owned vehicles but also when renting or borrowing vehicles. Privacy laws are personal, which means that for example consent does not carry over from one person to another in a household. Vehicles are in many cases shared by several individuals which means that consent cannot be stored by vehicle only. It has to be associated and carried by a person, otherwise the service provider can risk violating data privacy laws. The digital key concept together with the consent protocol using VSS solves this problem.

Embodiments moves control of personal data use from the device and cloud to a personally controlled entity—the digital key. The use of an open standard (VSS) for vehicle data enables the digital key to be used across brands, facilitating user consent management. The use of the vehicle signal specification (VSS) as a protocol for consent management provides a solution where digital keys are used to ensure that the drivers are able to be in charge of their personal data and its use. It also provides the industry with a powerful and easy to use “blueprint” to adhere and follow data privacy laws around the globe. It also gives the driver a key which he/she can use for this purpose regardless if he/she is driving his personal cars or renting or even loaning a vehicle from a friend. This cannot be realized without an open standard such as VSS. Note, that the solution does not require that VSS is being used internally, it only requires an interpretation of VSS. This can be handled by ontologies where proprietary vehicle signal specifications are mapped towards VSS and vice versa. VSS is used as a common language and protocol. Furthermore, VSS is human readable which makes it extra suitable as a protocol for user consent. The user/driver is able to understand the data being collected and the solution therefore reduces risk of unwanted data collection on the drivers' behalf.

Various embodiments are described with reference to the remote control of an automobile (or car). However, the disclosed techniques are not limited to automobiles and can be adapted to facilitate interacting with remote control used in various types of vehicles and modes of transportation (e.g., a truck, a bus, a train, an airplane, a boat, etc.). The disclosed techniques can also be applied to facilitate interfacing with content in other domains (e.g., other than vehicles) that generally employ remote control to interface with a system or device.

One or more embodiments are now described with reference to the drawings, wherein like referenced numerals are used to refer to like elements throughout. In the following description, for purposes of explanation, numerous specific details are set forth in order to provide a more thorough understanding of one or more embodiments. It is evident, however, in various cases, that one or more embodiments can be practiced without these specific details.

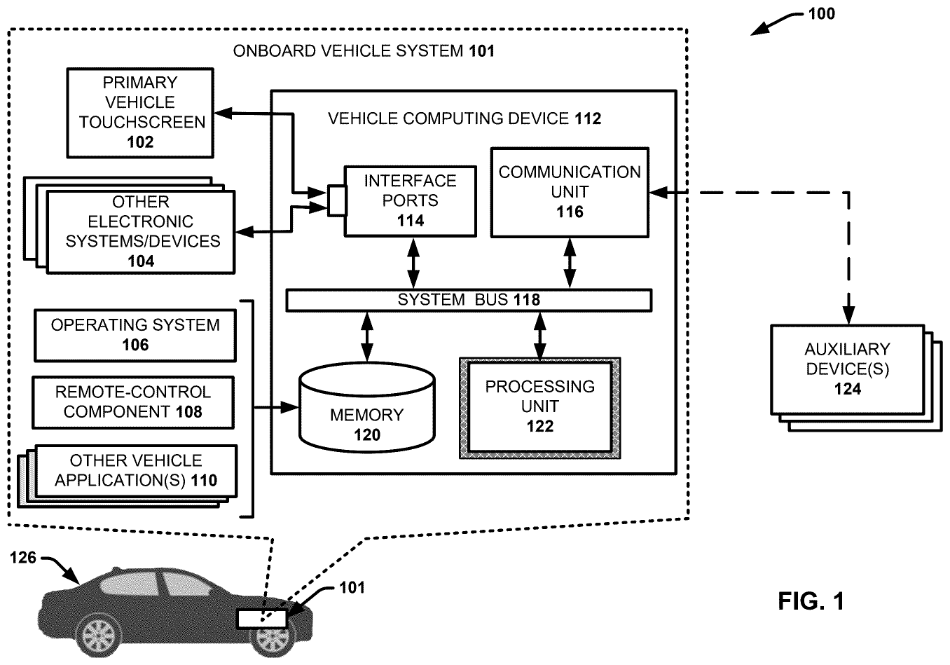

Turning now to the drawings, FIG. 1 illustrates a block diagram of an example, non-limiting system 100 that facilitates remotely controlling vehicle functions and applications accessed by touch controls displayed on a vehicle touchscreen rendered at an auxiliary device 124. In accordance with various exemplary embodiments, system 100 can be deployed on or within a vehicle, such as an automobile 126, to facilitate remotely accessing and controlling one or more functions or applications of the automobile 126.

In this regard, system 100 can include an onboard vehicle system 101 that comprises a primary vehicle touchscreen 102, one or more other electronic systems/devices 104 of the vehicle, and a vehicle computing device 112. System 100 further includes one or more auxiliary device(s) 124 that can be communicatively and operatively coupled to the vehicle computing device 112 of the onboard vehicle system 101 either via a wireless or wired connection.

The primary vehicle touchscreen 102 can display one or more interactive graphical user interface (GUI)s that facilitate accessing and/or controlling various functions and/or applications of the vehicle (e.g., automobile 126).

In this regard, the primary vehicle touchscreen 102 can comprise a display screen that serves as both an output display device and an input device for the vehicle computing device 112. The primary vehicle touchscreen 102 can comprise suitable hardware that registers input events in response to touch (e.g., by a finger, stylus, gloved hand, pen, etc.). The type of the primary vehicle touchscreen 102 can vary and can include, but is not limited to, a resistive touchscreen, a surface capacitive touchscreen, a projected capacitive touchscreen, a surface acoustic wave touchscreen, and an infrared touchscreen. In various embodiments, the primary vehicle touchscreen 102 can be positioned on the dashboard of the vehicle, such as on or within the center stack or center console of the dashboard. However, the position of the primary vehicle touchscreen 102 within the automobile 126 can vary.

Other electronic systems/devices 104 can include one or more additional devices and systems (e.g., in addition to the primary vehicle touchscreen 102 and the vehicle computing device 112) of the automobile 126 that can be controlled based at least in part on commands issued by the vehicle computing device 112 (e.g., via the processing unit122) and/or commands issued by the one or more auxiliary devices 124 communicatively coupled thereto. For example, the other electronic systems/devices 104 can include a media system (e.g., audio and/or video), a back-up camera system, a heating, ventilation, air-conditioning (HVAC) system, a lighting system, a cruise control system, a power locking system, a navigation system, a self-driving, a vehicle sensor system, and the like.

The vehicle computing device 112 can facilitate executing and controlling one or more operations of the vehicle, including one or more operations of the primary vehicle touchscreen 102, and the one or more other electronic systems/devices 104 using machine-executable instructions. In this regard, embodiments of system 100 and other systems described herein can include one or more machine-executable components embodied within one or more machines (e.g., embodied in one or more computer readable storage media associated with one or more machines, such as vehicle computing device 112). Such components, when executed by the one or more machines (e.g., processors, computers, computing devices, virtual machines, etc.) can cause the one or more machines to perform the operations described.

For example, the vehicle computing device 112 can include or be operatively coupled to at least one memory 120 and at least one processing unit 122. The processing unit 122 can be any of various available processors. Dual microprocessors and other multiprocessor architectures also can be employed as the processing unit 122. In various embodiments, the at least one memory 120 can store computer-executable instructions embodied as software functions/applications that when executed by the at least one processing unit 122, facilitate performance of operations defined by the executable instruction. In the embodiment shown, these computer-executable instructions or software components can include at least an operating system 106. The operating system 106 can act to control and allocate resources of the vehicle computing device 112. It is to be appreciated that the claimed subject matter can be implemented with various operating systems or combinations of operating systems.

These computer-executable instructions or software components can also include a remote-control unit 108, and one or more other vehicle applications 110. The remote-control unit 108 and/or the one or more other vehicle applications 110 can take advantage of the management of resources by operating system 106 through program modules and program data also stored in memory 120. The remote-control unit can perform vehicle actions originating at an auxiliary device and driven through a digital key server, regardless of the key's location, based on configuration and consent. The remote-control unit 108 can provide various features and functionalities that facilitate remote control of various vehicle functions (e.g., provided by the other electronic systems/devices 104) and applications (e.g., of the one or more other vehicle applications 110) by one or more auxiliary devices 124. For example, the one or more other vehicle applications 110 can vary and include for example, a navigation application, a media player application, a phone application, a vehicle settings application, a parking assistance application, an emergency roadside assistance application, and the like.

The vehicle computing device 112 can further include one or more interface ports 114, a communication unit 116, and a system bus 118 that communicatively couples the various components of the vehicle computing device 112 (e.g., the one or more interface ports 114, the communication unit 116, the memory 120 and the processing unit 122). The one or more interface ports 114 can connect the primary vehicle touchscreen 102 (and other potential input devices) and the one or more other electronic systems/devices 104 to the vehicle computing device 112. For example, the one or more interface ports 114 can include, a serial port, a parallel port, a game port, a universal serial bus (USB) and the like.

The communication unit 116 can include suitable hardware and/or software that facilitates connecting one or more auxiliary device 124 to the vehicle computing device 112 either via a wireless connection and/or a wired connection. In various embodiments, the communication unit 116 can facilitate establishing a wireless connection with one or more auxiliary devices 124 using one or more networks. Such networks lcan include wired and wireless networks, including but not limited to, a personal area network (PAN), a local area network (LAN), a cellular network, a wide area network (WAN, e.g., the Internet), and the like. For example, the one or more auxiliary devices 124 can communicate with the vehicle computing device 112 (and vice versa) using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), fifth generation partnership project (5G) communication system, third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, near field communication (NFC) technology, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. In this regard, the communication unit 116 can include software, hardware, or a combination of software and hardware that is configured to facilitate wired and/or wireless communication between the vehicle computing device 112 and the one or more auxiliary devices 124. While the communication unit 116 is shown for illustrative clarity as a separate unit that is not stored within memory 120, it is to be appreciated that one or more (software) components of the communication unit can be stored in memory 120 and include computer executable components.

The one or more auxiliary devices 124 can include any suitable computing device comprising a display and input device (e.g., a touchscreen) that can communicate with the vehicle computing device 112 and interface with the remote-control unit 108 (e.g., using a suitable application program interface (API). For example, the one or more auxiliary devices 124 can include, but are not limited to: a mobile phone, a smartphone, a tablet personal computer (PC), a digital assistant (PDA), a HUD, virtual reality (VR) headset, an augmented reality (AR) headset, or another type of wearable computing device, a desktop computer, a laptop computer, a television, an Internet enabled television and the like. As used in this disclosure, the terms “user,” “driver,” “passenger,” and the like refer to a person, machine, entity, system, or combination thereof that can employ system 100 (or additional systems described herein) using the primary vehicle touchscreen 102 and/or one or more auxiliary devices 124.

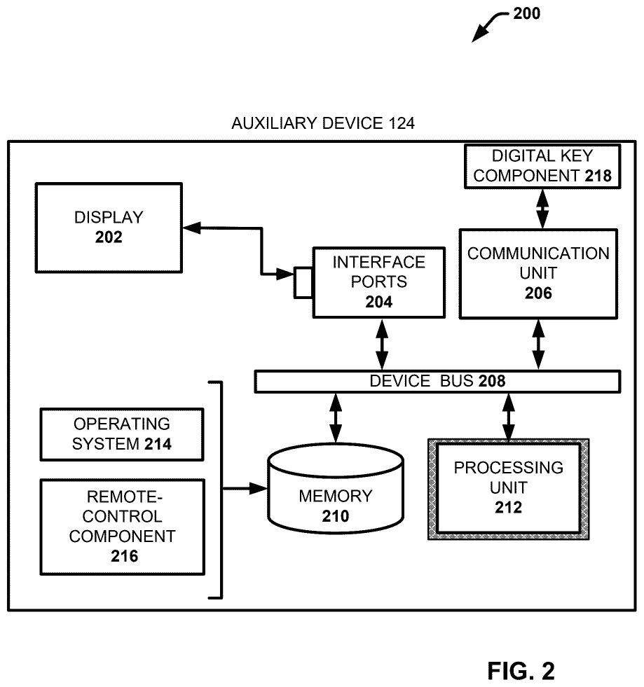

FIG. 2 illustrates a block diagram of an example, non-limiting auxiliary device 200 (e.g., of the one or more auxiliary devices 124) that facilitates remotely controlling vehicle functions and applications that are also accessed by touch controls displayed on a vehicle touchscreen in accordance with one or more embodiments described herein. In one or more embodiments, auxiliary device 200 can be or correspond to an auxiliary device of the one or more auxiliary devices 124 shown in system 100. In this regard, the one or more auxiliary device 124 can be or include one or more components of auxiliary device 200. Repetitive description of like elements employed in respective embodiments is omitted for sake of brevity.

In the embodiment shown, the auxiliary device 200 can include a display 202, one or more interface ports 204, a communication unit 206, at least one memory 210 and a processing unit 212. The at least one memory 210 can include computer executable components, including an operating system 214 and a remote-control application 216, that when executed by the processing unit 212, facilitate performance of operations defined by the computer executable components. The remote control component or application can communicate to the digital key component via the memory 210, the device bus 208, the communication unit 206 and finally the digital key component 218. This digital key component can reside within the auxiliary device or in a cloud platform or both. For this example, it is defined to reside in the auxiliary device. This digital key component 218 can communicate with external cloud-based servers to verify security content and other compliance parameters before directing data to the remote-control component to act. The operating system 214 can vary depending on the type of auxiliary device 200, however the operating system can provide same or similar features and functionalities as operating system 106. In some embodiments, the display 202 can comprise a touchscreen. In accordance with these embodiments, the display 202 can provide same or similar features and functionalities as the primary vehicle touchscreen 102. In other embodiments, the display 202 can include standard display without a touchscreen that is coupled to one or more other input devices (e.g., a touchpad, a keyboard, one or more electromechanical buttons/knobs, etc.) to facilitate interfacing with a GUI rendered on the display). The one or more interface ports 204 can provide same or similar features and functionalities as the one or more interface ports 114, and the communication unit 206 can provide same or similar features and functionalities as communication unit 116. The auxiliary device 200 can further include a device bus 208 to communicatively couple the various components/devices of the auxiliary device 200 (e.g., the display 202, the one or more interface ports 204, the communication unit 206, the at least one memory 210 and the processing unit 212).

As noted with reference to FIG. 1, in one or more embodiments, the onboard vehicle system 101 can include a remote-control unit 108 to facilitate remote control of one or more vehicle functions and/or applications by an auxiliary device, such as auxiliary device 200. In accordance with various embodiments described herein, the auxiliary device 200 can include remote-control application 216 to facilitate remotely controlling the vehicle functions and applications in conjunction with the remote-control unit 108. For example, the remote-control application 216 can facilitate establishing a remote-control session between the auxiliary device 200 and the vehicle computing device 112, facilitate issuing and communicating control commands to control one or more vehicle functions/application issued from the auxiliary device, facilitate controlling display of a GUI at the auxiliary device 200 including interactive graphical elements (e.g., touch controls) to access and/or control one or more vehicle functions/applications, and the like.

In some implementations of these embodiments, with reference FIGS. 1 and 2, the vehicle computing device 112 and the one or more auxiliary devices 124 can operate in a server/client type relationship. Both devices can implement digital key configuration to limit erroneous actions not consented to by a user. Further, in some implementations, the vehicle computing device 112 and/or the one or more auxiliary devices 124 can employ a web-based platform (e.g., a website, a thin client application, a thick client application, etc.) to execute the features and functionalities of the remote-control unit 108 and/or the remote-control application 216. According to these embodiments, the remote-control application 216 can be or correspond to a thin client application, a thick client application, a hybrid application, or the like, that is configured to access and interface with the remote-control unit 108 either directly or via a web-based server.

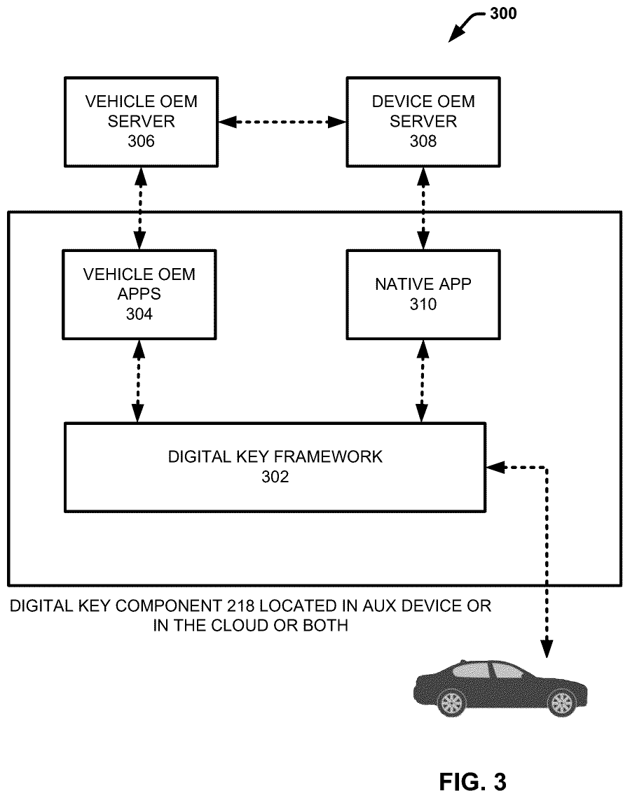

FIG. 3 illustrates a block diagram of an example non-limiting digital key incorporated auxiliary device communication flow to external servers in accordance with one or more embodiments described herein. When vehicle digital keys communicate with the vehicle using cloud-based servers, the process typically involves a combination of mobile applications, internet connectivity, and backend systems. The digital key component as depicted in FIG. 2 is identified as 218. This component contains a digital key framework 302 which can be data storage, a mechanism to process data, and the primary communication portal to the vehicle.

Users typically interact with their digital keys through a mobile application 304 provided by the vehicle manufacturer or a third-party service provider. The mobile app serves as the interface for managing digital keys, such as adding or removing keys, granting access permissions, and remotely controlling vehicle functions. The digital keys and associated permissions can be stored and managed on cloud-based servers maintained by the vehicle manufacturer or a related service provider. A vehicle OEM server 306 would be communicating with the OEM app located in the auxiliary device. The OEM server then can communicate with the auxiliary device server 308 for any confirmations or compliance that may not have been confirmed by the OEM app 304 or the OEM server 306. These servers 306 and 308 can handle authentication, authorization, and encryption of communication between the mobile app and the vehicle. Both the mobile app and the vehicle need to have internet connectivity to communicate with the cloud-based servers. This can be achieved through Wi-Fi, cellular data connections (e.g., 4G/5G), or a combination of both.

When a user interacts with the mobile app to perform actions such as unlocking the vehicle or starting the engine, the app 304 sends encrypted commands to the cloud-based servers 306 and possibly 308 if required. The servers 306 and 308 authenticate the user and verify the permissions associated with the digital key. Once the cloud-based servers authenticate the user and authorize the requested action, typically the device OEM server 308 can send encrypted message data to a native app 310 within the auxiliary device to process the data via a secure communication channel. This communication may involve protocols such as HTTPS (HTTP Secure) or MQTT (Message Queuing Telemetry Transport) to ensure data integrity and confidentiality. The digital key framework system can work as a middle-man to receive the messages from the native app 310 and pass those instructions on to the vehicle and execute the requested actions, such as unlocking the doors or starting the engine. Feedback may be sent back to the cloud servers to confirm the successful execution of the command.

By leveraging cloud-based infrastructure, vehicle digital keys can offer enhanced functionality, flexibility, and security. Users can remotely manage access to their vehicles and monitor their status, while manufacturers can implement advanced security measures and quickly deploy updates or patches to address potential vulnerabilities.

FIG. 4 presents a diagram of the basic Vehicle Signal Specification (VSS) layout in accordance with one or more embodiments described herein. The VSS is the foundation for the invention, by defining a common protocol based on the vehicle signal specification the digital key can be used across OEMS and across services provided. As depicted on FIG. 4, the VSS signals are formatted out as a data tree type structure. The vehicle set 402 is split into various subsets that are various data points for the vehicle itself. Parameters such as the vehicle identification 404 which is then divided into another subset 406 which carries more detailed about the vehicle. Data points 410 identify the current location with latitude and longitude data points. This tree can be as wide and deep as the user would like to configure based on standards. By adding and applying the vehicle signal tree to user consent we are able to monitor consent on a data point “atomic” level. The digital key can exist physically in the cloud or on a personal device or on both.

The consent enabled digital key provides a solution on an individual basis. The implementation of the consent enabled digital key is facilitated by the use VSS. The vehicle signal specification is a tree-based data model which gives the data point granularity needed. For example, to express that a service uses all possible data points enter: vehicle.*. If a service uses location-based data, the key should just need to add Vehicle.CurrentLocation. (latitude and longitude) into its consent management file as shown below.

### Key—Individual Identification

Vehicle ID 1
   Service 1
      YES→Vehicle.*
   Service 2
      YES→Vehicle.location.latitude
      YES→Vehiclelocation.longitude
      YES→Vehicle.Speed
Vehicle ID 2
   Service 1
      NO
   Service 2
      YES→Vehicle.location.latitude
      YES→Veiclelocation.longitude
      YES→Vehicle.Speed

The following figure shows a snapshot in time of a possible consent stored and associated with a digital key. It is using valid JSON as storage format.

| | |
|---|---|
| “Vehicles” | List of vehicles associated with digital key |
| “VehicleId” | A unique global identifier such as VIN |
| “Services” | A list of services per vehicle |
| “service-id” | Unique global service identifier |
| “consent” | VSS specified vehicle data signals |
| | reflecting user consent per service |

The JSON contains a list of Vehicles identified by a unique global identifier such as the VIN. The JSON file is the basis for the consent management. The file thus needs to be associated with the digital key. If the digital key is realized on a smart watch or smart phone this is achieved using standard software engineering methodology. The VSS also allows us to extend its data model with a service name and a vehicle identifier. VSS has a concept defined called layering which can be used to add Vehicle.Service and Vehicle.Private.ID. The digital key carries the consent data and is used as a “plugin” for a vehicle consent management system. When we unlock the vehicle, the personal consent data is available for the vehicles' consent management system. It could then be presented by the vehicles infotainment system.

The VSS can support multiple vehicle ID's as shown below. The data structure below identifies 2 separate vehicles depicted as vehicleId: xxx-yyy-111 and xxx-yyy-222. This flexibility can allow multiple brands to be supported. OEM's could also use independent 3^{rd} party apps if they use this data model and the OEM's decide to accept this universally as long as consent format (JSON/VSS) is maintained.

```
{
  “Vehicles”: [
    {
      “VehicleId”: [symbol]
      “Services”: [
        {
          “service-id”: “parkster”,
          “vss-consent-tree”: [
            “Vehicle.Speed”,
            “Vehicle.CurrentLocation,*”
          ]
        },
        {
          “service-id”: “charger”,
          “vss-consent-tree”: [
            “Vehicle.Speed”,
            “Vehicle.CurrentLocation.*”
          ]
        }
      ]
    },
  {
    “VehicleId”: [symbol]
    “Services”: [
      {
        “service-id: “mapper”,
        “vss-consent-tree”: [
          “Vehicle.speed”,
          “Vehicle.CurrentLocation.*”
        ]
      },
      {
        “service-id”: payee”,
        “vss-consent-tree”:
          “Vehicle.*”
```

The consent protocol is a data model, so it is not source code. However, the protocol or the translation of proprietary signal names could be handled by every OEM, they have to adhere to the VSS data model. So, this implies that they need a translator or “natively” handle data signals in VSS (natively speak VSS in other words). On top of VSS there is the service for which the consent is given or not given. So, the protocol is the consent context+the actual consent data description in VSS.

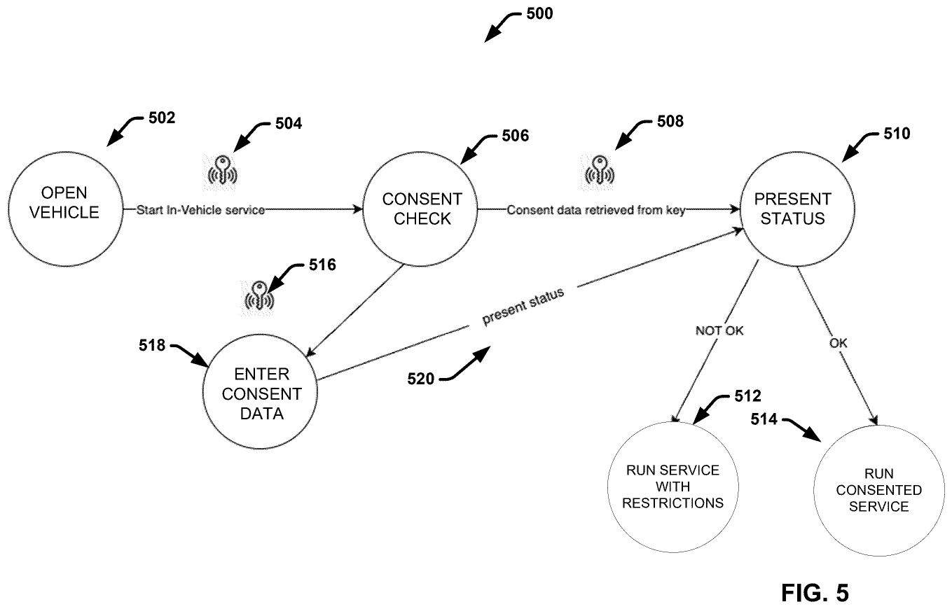

FIG. 5 presents an illustration of an example, non-limiting remote-control application utilizing a digital key with consent configuration in accordance with one or more embodiments described herein. The process starts with an individual attempting to open a vehicle 502 using a “start in vehicle service’ 504 on an auxiliary device. Then the digital key will check if there is consent for this action to happen 506, so the consent has to be retrieved from the key itself. If there no consent data in the key 516, then consent has to be entered in 518. The origin of the consent could reside in the key or a server in the cloud. If consent is confirmed via 520 or 508, the current status of the request would be evaluated at 510. At this point, the consent could be comprehensive or may have certain restrictions. From this review, the final outcome will be to allow the driver execute the request completely 514 or execute the request with some restrictions 512—whatever they may be in the VSS file.

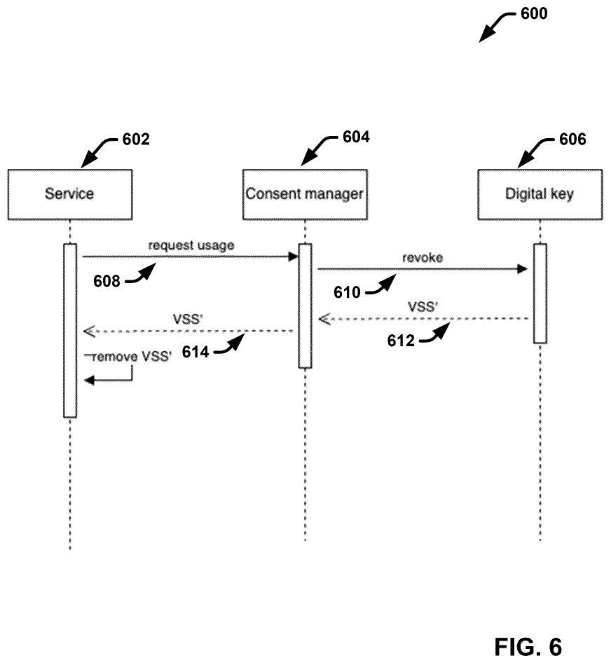

FIG. 6 illustrates a communication diagram of consent being revoked related to the usage of a digital key and VSS in accordance with one or more embodiments described herein. This diagram is a depiction of a request for service that will be revoked due to a lack of consent. The service request is initiated at 602 and then will be considered for acceptance between the consent manager 604 and the digital key 606—it's important to note this acceptance resides in the VSS and the response to this can come from the digital key that contains the consent data. The consent manager 604 and the digital key 606 may be working together or separately in the cloud. For this example, the consent is revoked by the digital key and the message sent back to the consent manager which prevents the execution of the action. Then the VSS' 612 subset of data points is removed 614 and the collected data can easily be searched and destroyed. One of the requirements is that the user should be able to revoke previous decisions and all data collected tied to a specific service should then be removed from VSS as shown below by the command that can be used.

REMOVE:
key.REMOVE(<serviceindentifier>, <vss tree signal paths>, <vehicldentifier>)

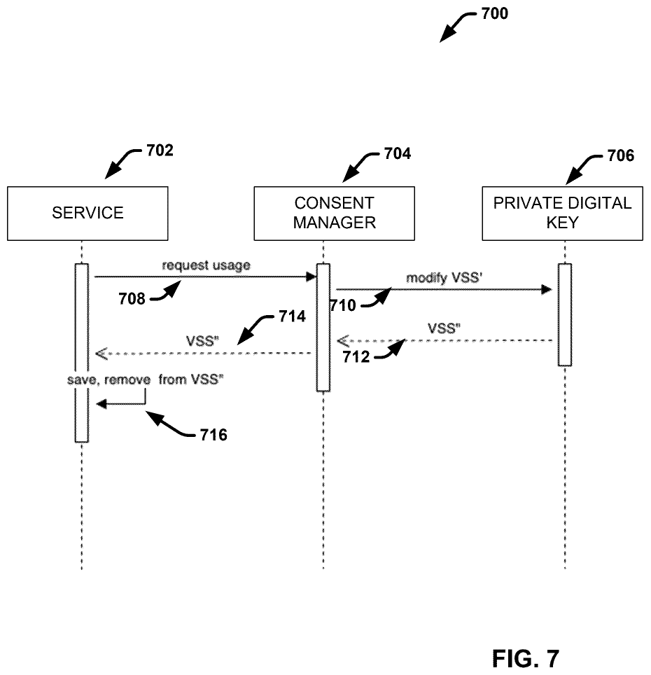

FIG. 7 illustrates a communication diagram of modifying consent related to the usage of a digital key and VSS in accordance with one or more embodiments described herein. This diagram is a depiction of a request for service that is to be modified to another type of service. The service request and a modification are initiated at 702 and the message 708 is sent to the consent manager 704 and then will be considered for acceptance 710 between the consent manager 704 and the digital key 706—it's important to note this acceptance resides in the VSS and the response to this can come from the digital key that contains the response data. The consent manager 704 and the digital key 706 may be working together or separately in the cloud. For this example, the modification is accepted then sent back through the consent manager 712 and back to VSS for modification 714 and 716. The modification will be executed by first removing the data point and then replacing it with the modified data point 716. One of the requirements is that the user should be able to modify previous decisions and all data collected tied to a specific service should then modified from VSS as shown below by the command that can be used. The solution also lets a user redefine the data being collected for a specific service by modifying (using CHANGE function) the previously provided tree paths.
CHANGE:
   key.CHANGE(<serviceindentifier, <vss tree signal paths>, <vehicle identifier>)

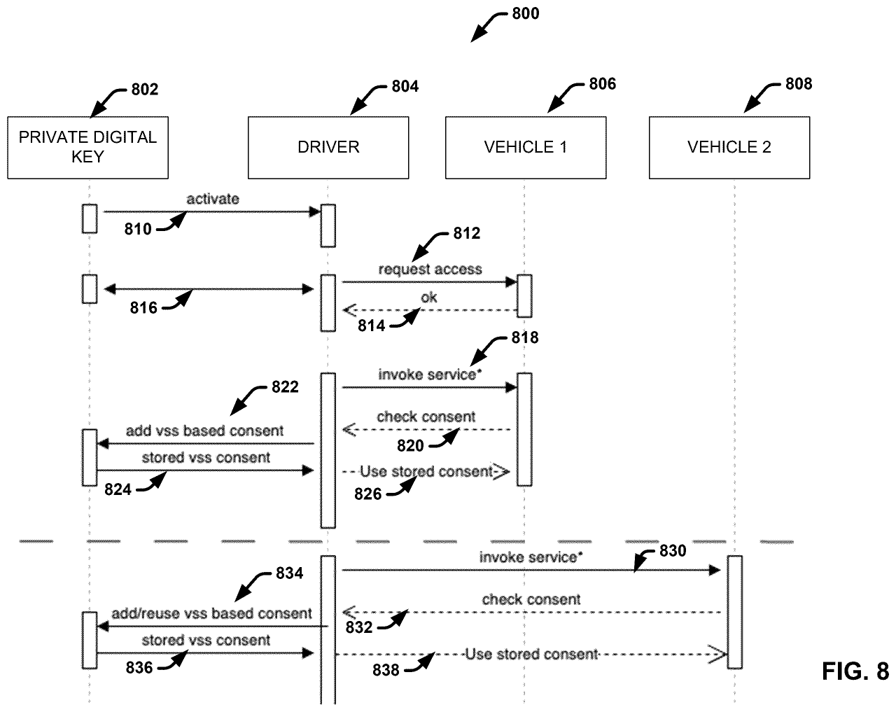

FIG. 8 illustrates a communication diagram of a digital key and VSS supporting multiple OEM (vehicle brands) in accordance with one or more embodiments described herein. It seems the activate is initiated at the private digital key. The request is activated through the private digital key 802 to the driver 804 and then follows to Vehicle 1 806 where the access response is decided. Vehicle 1 responds with an OK 814 which is sent back to the driver and the digital key 816. This is a validation that the driver, the key and the vehicle can all communicate. At this point the driver invokes a service 818 to the vehicle for an action and the vehicle system/digital key or a cloud-based server will check consent 820. The driver can add consent and this information is sent to the digital key 822 and stored in VSS. The next step for this stored consent to return back to Vehicle 1 (824, 826) to execute the requested service initiated. The next scenario if for the driver to request service for a different brand vehicle (Vehicle 2) using the same application as he did for Vehicle 1. The driver invokes service at 830 to Vehicle 2 and the same concept is followed, there is consent check back to the driver 832—and at this point there would have to be a check in VSS. The consent for this VIN could already be stored in VSS. If not the driver could add it 834, then the stored VSS consent is sent back to (836, 838), at this point Vehicle 2 would have to have a 3^{rd} party software program or an interpretation program as this response is from a unknow application. Assuming there is consent or its added, the stored consent is sent back to Vehicle 2 to execute the service requested.

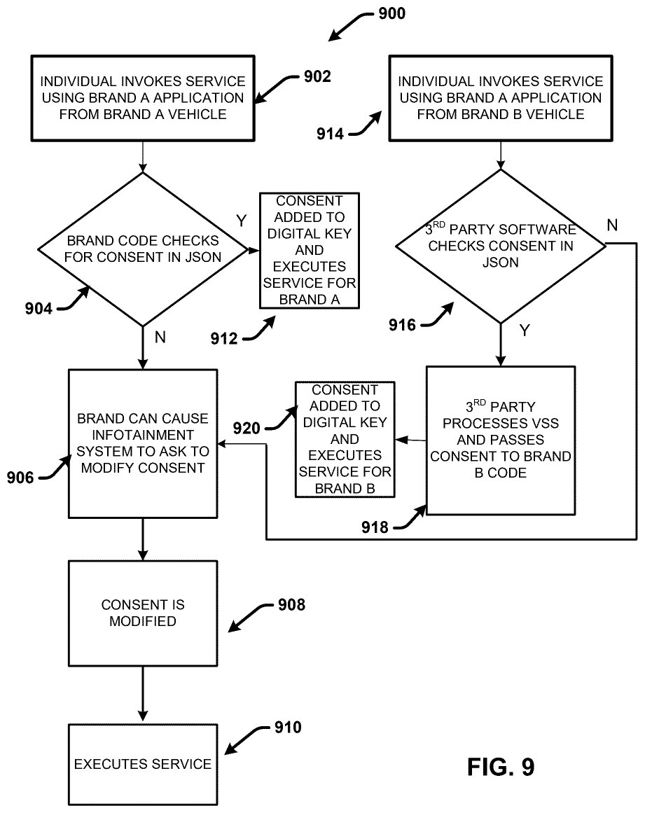

FIG. 9 illustrates a flow diagram of a digital key and VSS supporting multiple OEM (vehicle brands) in accordance with one or more embodiments described herein. An individual invokes a service from a Brand A vehicle at 902 from the same brand as the application (Brand A) (this is the standard procedure). The brand code checks for consent in 904 in the JSON file and if it's a yes, the consent is added to the digital key and the service is executed 912. If there is no consent the brand can cause the infotainment system in the vehicle to ask if consent should be added 906. Then if consent is modified by adding it or changing it 908, the service will be executed 910.

For the second scenario, an individual invokes a service from Brand B vehicle using an application from Brand A 914. This will use the invention as multiple brands can be supported. A 3^{rd} party software package checks consent in the JSON file 916 and if there is no consent, Brand B can cause the infotainment system to ask for consent 920. Now the consent can be modified, and the service can be executed (908 and 910). If there is consent, the 3^{RD} party software will process the VSS and pass the consent to the Brand B code 918. At this point the consent is added to the digital key and the service is executed 920.

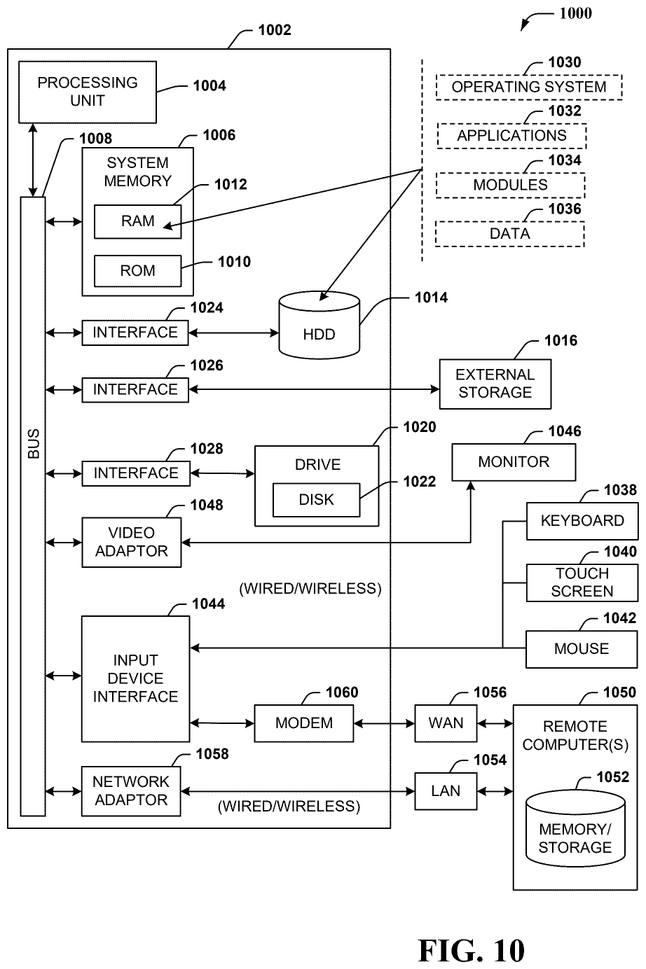

With reference to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

The computer 1002 can operate in a networked environment using logical connections via wireless communications based GPRS, GSM, 5G, LTE, 6G protocols.

When used in a LAN networking environment, the computer 1002 can be connected to the local network 1054 through a wired or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

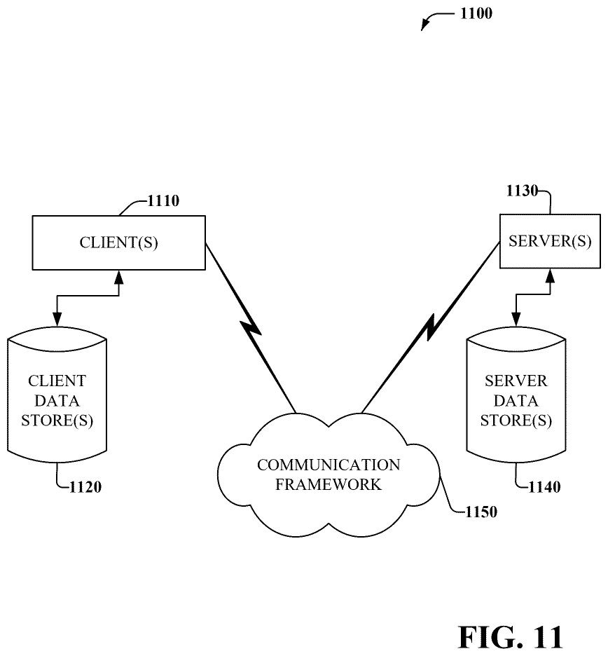

FIG. 11 is a schematic block diagram of a sample computing environment 1100 with which the disclosed subject matter can interact. The sample computing environment 1100 includes one or more client(s) 1110. The client(s) 1110 can be hardware or software (e.g., threads, processes, computing devices). The sample computing environment 1100 also includes one or more server(s) 1130. The server(s) 1130 can also be hardware or software (e.g., threads, processes, computing devices). The servers 1130 can house threads to perform transformations by employing one or more embodiments as described herein, for example. One possible communication between a client 1110 and a server 1130 can be in the form of a data packet adapted to be transmitted between two or more computer processes. The sample computing environment 1100 includes a communication framework 1150 that can be employed to facilitate communications between the client(s) 1110 and the server(s) 1130. The client(s) 1110 are operably connected to one or more client data store(s) 1120 that can be employed to store information local to the client(s) 1110. Similarly, the server(s) 1130 are operably connected to one or more server data store(s) 1140 that can be employed to store information local to the servers 1130.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

One or more embodiments of the present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Various aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing one or more embodiments, but one of ordinary skill in the art can recognize that many further combinations and permutations of these embodiments are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The terminology used herein was chosen to best explain the principles of the embodiments, the practical application or technical improvement over technologies found in the marketplace, or to enable others of ordinary skill in the art to understand the embodiments disclosed herein. In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various non-limiting aspects of various embodiments described herein are presented in the following clauses.
1. A system, comprising: a processor; and a memory communicatively coupled to the processor, the memory having stored therein computer-executable instructions, comprising: a remote-control component with a private digital key that enables a user to remotely control one or more functions of a vehicle and store information; and a digital key component that adds a new protocol to a private digital key to regulate consent management for a vehicle and support multiple brands.
2. The system of any preceding clause, wherein the private digital key uses an open vehicle data standard.
3. The system of any preceding clause, wherein a vehicle data standard is VSS (vehicle signal specification).
4. The system of any preceding clause, wherein the protocol is an extension of the private digital key and its functions.
5. The system of any preceding clause, wherein the private digital key can reside in a cloud environment or a personal device.
6. The system of any preceding clause, wherein the private digital key is specifically tied to an individual.
7. The system of any preceding clause, wherein the private digital key stores and keeps track of consent per service and per vehicle.
8. The system of any preceding clause, wherein the private digital key supports multiple vehicles regardless of the vehicle being personal, loaned, rented or other.
9. The system of any preceding clause, wherein the consent management system is an integrated part of vehicle services and applications and stored with a private digital key identifier.
10. The system of any preceding clause, wherein the services and applications check the private digital key for acceptance or rejection when they are executed.

In various cases, any suitable combination or combinations of clauses 1-10 can be implemented.
11. A computer implemented method, comprising: enabling by the system using a digital key the remote control of one or more functions of the vehicle and store information; and adding by the system, a new protocol to the private digital key to regulate consent management for a vehicle and support multiple brands.
12. A computer implemented method of any preceding clause, further comprising using by the system, an open vehicle data standard.
13. A computer implemented method of any preceding clause, further comprising employing by the system, VSS as the open vehicle standard.
14. A computer implemented method of any preceding clause, further comprising extending by the system, the protocol of the private digital key and its functions.
15. A computer implemented method of any preceding clause, further comprising locating by the system, the private digital key that can reside in the cloud or the device.
16. A computer implemented method of any preceding clause, further comprising connecting by the system, the personal digital key to a specific individual.
17. A computer implemented method of any preceding clause, further comprising storing by the system, data regarding the private digital key that tracks of consent per service and per vehicle.
18. A computer implemented method of any preceding clause, further comprising supporting by the system, a private digital key that can manage multiple vehicles regardless of the vehicle being personal, loaned, rented or other.
19. A computer implemented method of any preceding clause, wherein the consent management system is an integrated part of vehicle services and applications and stored with a private digital key identifier.
20. A computer implemented method of any preceding clause, further comprising accepting or rejecting by the system, the services and applications based on the private digital key.

In various cases, any suitable combination or combinations of clauses 11-20 can be implemented.

What is claimed is:

1. A system, comprising:
a processor; and
a memory communicatively coupled to the processor, the memory having stored therein computer-executable instructions, comprising:
a remote-control component with a private digital key that enables a user to remotely control one or more functions of a vehicle and store information; and
a digital key component that adds a new protocol to a private digital key to regulate consent management for a vehicle and support multiple brands.

2. The system of claim 1, wherein the private digital key uses an open vehicle data standard.

3. The system of claim 2, wherein a vehicle data standard is VSS (vehicle signal specification).

4. The system of claim 1, wherein the protocol is an extension of the private digital key and its functions.

5. The system of claim 2, wherein the private digital key can reside in a cloud environment or a personal device.

6. The system of claim 2, wherein the private digital key is specifically tied to an individual.

7. The system of claim 2, wherein the private digital key stores and keeps track of consent per service and per vehicle.

8. The system of claim 2, wherein the private digital key supports multiple vehicles regardless of the vehicle being personal, loaned, rented or other.

9. The system of claim 1, wherein the consent management system is an integrated part of vehicle services and applications and stored with a private digital key identifier.

10. The system of claim 9, wherein the services and applications check the private digital key for acceptance or rejection when they are executed.

11. A computer implemented method, comprising:
enabling by the system using a digital key the remote control of one or more functions of the vehicle and store information; and
adding by the system, a new protocol to the private digital key to regulate consent management for a vehicle and support multiple brands.

12. The computer implemented method of claim 10, further comprising using by the system, an open vehicle data standard.

13. The method of claim 12, further comprising employing by the system, VSS as the open vehicle standard.

14. The computer implemented method of claim 10, further comprising extending by the system, the protocol of the private digital key and its functions.

15. The computer implemented method of claim 14, further comprising locating by the system, the private digital key that can reside in the cloud or the device.

16. The computer implemented method of claim 14, further comprising connecting by the system, the personal digital key to a specific individual.

17. The computer implemented method of claim 10, further comprising storing by the system data regarding the private digital key that tracks of consent per service and per vehicle.

18. The computer implemented method of claim 10, further comprising supporting by the system, a private digital key that can manage multiple vehicles regardless of the vehicle being personal, loaned, rented or other.

19. The computer implemented method of claim 10, wherein the consent management system is an integrated part of vehicle services and applications and stored with a private digital key identifier.

20. The computer implemented method of claim 10, further comprising accepting or rejecting by the system, the services and applications based on the private digital key.
